(19) United States
(12) Patent Application Publication
(10) Pub. No.: US 2006/0041904 A1
(43) Pub. Date: Feb. 23, 2006

(54) Broadcasting system and control method thereof

(75) Inventor: Jong Goo Lee, Busan (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/168,335

(22) Filed: Jun. 29, 2005

(30) Foreign Application Priority Data
Aug. 20, 2004 (KR) P10-2004-0065764

(51) Int. Cl. H04N 7/16; H04N 5/445; G06F 13/00; G06F 3/00

(52) U.S. Cl. 725/28; 725/46

(57) ABSTRACT

A broadcasting system and a control method thereof providing convenient channel selection are provided. In the method, channel rating information is transmitted from a broadcasting station to a display device. Channel priority is determined based on the transmitted channel rating information. Channel information is displayed on the display device according to the channel priority.

This application claims the benefit of the Korean Patent Application No. 10-2004-0065764, filed on Aug. 20, 2004, which is hereby incorporated by reference.

### BACKGROUND OF THE INVENTION

1. Field of the Invention

The present invention relates to a broadcasting system, and more particularly, to a broadcasting system and a control method thereof that provide convenient channel selection.

2. Discussion of the Related Art

A television (TV) is the most typical example of a display device. The TV selects a broadcasting signal transmitted from a broadcasting station according to a user's selection, and displays the selected broadcasting signal on its screen. The TV is gradually changed from an analogue TV into a digital TV with the development of multimedia technology.

The digital TV provides various additional services such as a home shopping service, an electronic newspaper service, a stock information service, and so on, and provides many broadcasting channels through efficient use of a broadcasting bandwidth.

Since standards for an interactive service such as an online game service or a video-on-demand (VOD) service are being determined, manufacturers actively conduct a study on an interface for the interactive service. A digital TV receiver or an Internet TV, which is currently being developed, provides a graphic user interface (GUI) having the same level as that of a personal computer (PC). A typical example of the GUI includes an electronic program guide (EPG) that is guide information about broadcasting programs. The EPG displays information about broadcasting programs on a screen by date and time. This EPG function aims at enhancing user convenience for coping with the complexity and variety of a digital TV.

FIG. 1 illustrates a block view showing a structure of a general image display device. FIG. 2 illustrates a flow chart showing a method for controlling the general image display device of FIG. 1. As shown in FIG. 1, the general image display device includes a tuner 11, an IF signal processor 12, an image signal processor 13, a channel selection information storage 19, a remote controller 14, a remote receiver 15, a key pad 16, a controller 17, an OSD message generator 18, and a synthesizer 20. The tuner 11 is used for selecting a broadcasting signal received through an antenna 10. The IF signal processor 12 receives and amplifies the broadcasting signal selected by the tuner 11. The image signal processor 13 processes the image signal processed by the IF signal processor 12 so that the image signal can be displayed on a display unit 21. The channel selection information storage 19 stores channel selection information. The remote controller 14 is used for transmitting a viewer's request command from a remote distance. The remote receiver 15 is used for receiving the viewer's request command transmitted from the remote controller 14.

The controller 17 controls operations of each element of the display device (or television receiver) according to the request command inputted through the remote receiver 15 or the key pad 16. The controller 17 also stores the channel selection information that is processed from the IF signal processor 12 in the channel selection information storage 19 and outputs a control signal in accordance with the viewer's request. The OSD message generator 18 generates OSD messages in accordance with the control signal of the controller 17. The synthesizer 20 synthesizes the image signal processed by the image signal processor 13 and the message generated from the OSD message generator 18, so that the image signal and the message can be displayed on the display unit 21.

The operation of the general image display device having the above-described structure will now be described in detail. When the viewer inputs a ‘Power On’ command by using the remote controller 14 or the key pad 16, the controller 17 transmits a control signal to the tuner 11 to allow a channel desired by the viewer to be selected. Subsequently, the tuner 11 selects the channel desired by the viewer. The broadcasting signal of the selected channel is inputted to the IF signal processor 12, and the broadcasting signal is then separated into a video signal, an audio signal, and additional information. Thereafter, the image signal is inputted to the image signal processor 13, which is then converted to a signal that can be displayed on the display unit 21.

The channel information of one of the channels, which are selected by using the remote controller 14 or the key pad 16, being further selected as a preferred (or frequently viewed) channel is stored in the channel selection information storage 19. Then, in accordance with the viewer's request command, a change in channels may only be performed among the channels selected and memorized (or remembered) by the channel selection information storage 19. More specifically, when a channel selection command is inputted through the remote controller 14 or the key pad 16, the controller 17 transmits a set of tuning data to the tuner 11. Then, the controller 17 searches for the channels in which synchronization signals exist, and the channel selection information storage 19 memorizes the corresponding channel number. Thereafter, in accordance with the viewer's request, the controller 17 sequentially calls (or summons) the channel numbers, which are aligned in sequential order. Then, the called (or summoned) channels are selected as the preferred (or frequently viewed) channels.

Referring to FIG. 2, the display device determines whether the user inputted the preferred channel key (S1). Then, in accordance with the result of Step 1, if the user inputted the preferred channel key, the display device receives and decodes the received Broadcasting Program System signal (S2). Subsequently, the channel number, program code, and time information of the channel, which is currently being viewed, are stored (S3). Finally, the display mode of the television receiver (or the display device) is set as the “preferred channel selected” mode.

However, the existing digital TV provides a function for storing several channels, but does not provide a function for effectively managing and using many channels. Accordingly, the existing digital TV cannot provide convenient channel selection because many channels must be individually scanned to select a desired broadcasting program or channel.

### SUMMARY OF THE INVENTION

Accordingly, the present invention is directed to a broadcasting system and a control method thereof that substantially obviate one or more problems due to limitations and disadvantages of the related art.

An object of the present invention is to provide a broadcasting system and a control method thereof that provide convenient channel selection.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for controlling a broadcasting system, the method including the steps of: receiving channel rating information from a broadcasting station; determining channel priority based on the received channel rating information; and displaying channel information on a display device according to the determined channel priority.

In another aspect of the present invention, a broadcasting system includes: a server of a broadcasting station, the server generating and outputting channel rating information; and a display device to determine channel priority based on the channel rating information and to display channel information according to the determined channel priority.

In another aspect of the present invention, there is provided a display device comprising: a receiver to receive channel viewing rating information from an external source, a controller to determine channel priority based on the received channel viewing rating information, and a display unit to display channel information according to he determined channel priority.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block view showing a structure of an image display device according to a related art;

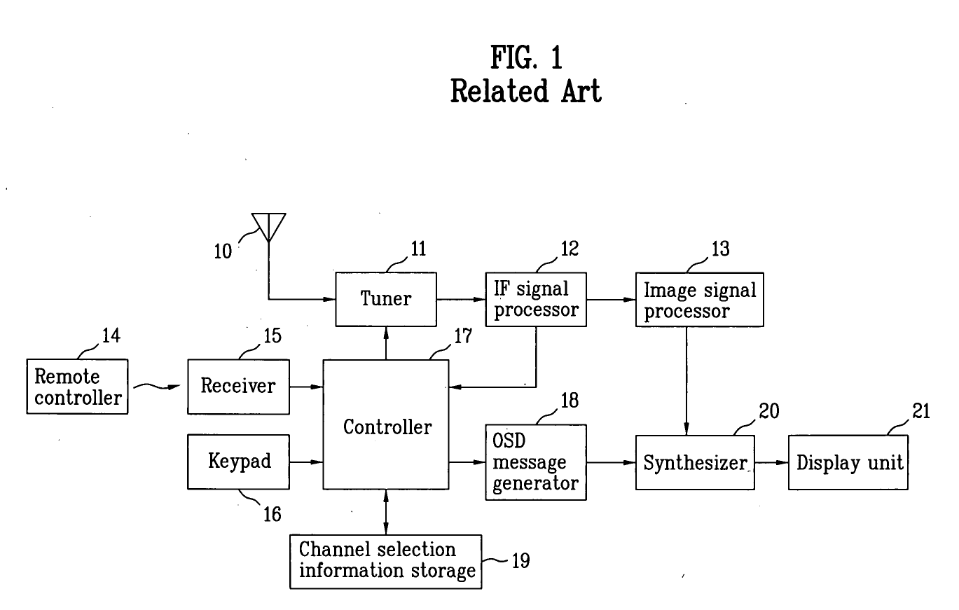

FIG. 2 illustrates a flow chart showing a method for setting preferred channels according to the related art;

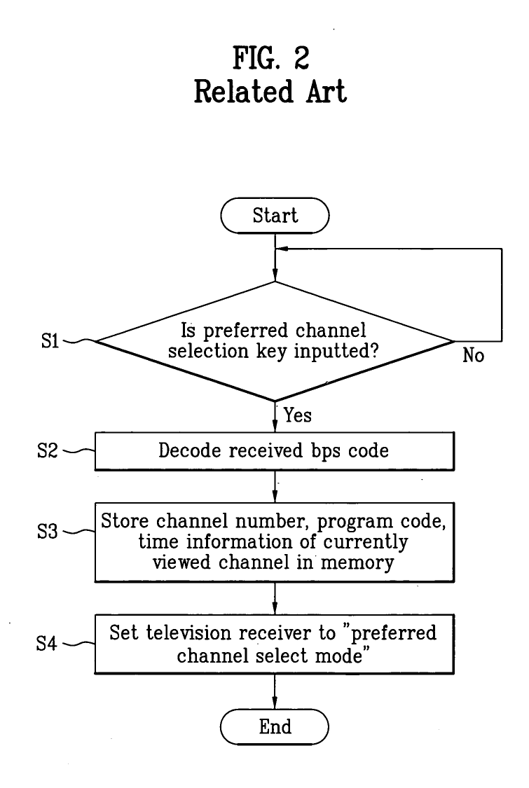

FIG. 3 illustrates a block diagram of a broadcasting system according to the present invention;

FIG. 4 illustrates a flow chart showing a method for controlling a broadcasting system according to the present invention;

FIG. 5 illustrates an example of a menu for preferred channel settings; and

FIG. 6 illustrates a list of favorite channels based on program ratings.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

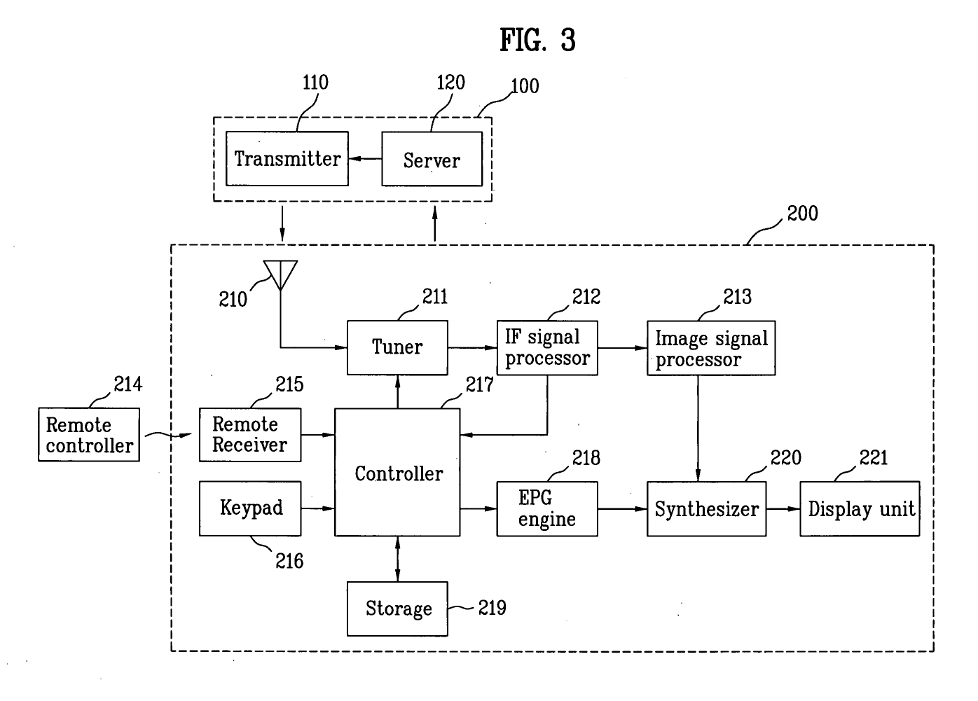

FIG. 3 is a block diagram of a broadcasting system according to the present invention.

Referring to FIG. 3, an inventive broadcasting system includes a transmitter 110 and a server 120 of a TV broadcasting station 100, and a display device 200. The server 120 calculates a channel rating (or viewership per channel) on the basis of information received from a plurality of display devices 200 through a network such as the Internet, intranet, extranet, etc., and generates channel rating information based on the calculated rating. The transmitter 110 transmits through air wave a broadcasting signal and the channel rating information to the display devices.

The display device 200 transmits information about a selected channel to the server 120, determines channel priority based on the channel rating information received from the transmitter 110, and then selects a channel according to the determined channel priority. The display device 200 may be any device capable of receiving a TV broadcasting signal, such as a digital TV, an Internet TV, and a digital multimedia broadcasting (DMB) terminal.

The display device 200 includes a key input unit. The key input unit includes at least any one of a remote controller 214 and a keypad 216. A remote receiver 215 of the display device 200 receives a user command inputted through the remote controller 214. A keypad 216 for inputting a user command is installed in a main body of the display device 200. In response to a user command inputted through the remote receiver 215 or the keypad 216, the tuner 211 selects a desired channel from a broadcasting signal received through an antenna 210, a set-top box, or a cable. An intermediate frequency (IF) signal processor 212 receives a radio frequency (RF) image signal out of a broadcasting signal of a channel selected by the tuner 211, and amplifies the received RF image signal. An image signal processor 213 converts an image signal outputted from the IF signal processor 212 into displayable data.

A controller 217 transmits information about a channel selected through the remote receiver 215 or the keypad 216 and information about a current channel (broadcasting program) to the server 120, and selects a channel according to the channel rating information generated by the server 120. A storage 219 stores the channel rating information received from the transmitter 110, a channel selection history, and a channel viewing history. The channel selection history includes one or more of a selected channel number, a selection time of a channel, and the number of times of channel selection. The channel viewing history includes one or more of a viewed channel number, a viewing start time of a channel, the total viewing period of a channel, and the number of times of channel viewing.

An EPG engine 218 receives EPG information from the transmitter 110, and generates an EPG based on the received EPG information. A synthesizer 220 synthesizes the image signal outputted from the image signal processor 213 and the EPG generated from the EPG engine 218 so as to display them on the display unit 221.

A method for controlling the inventive broadcasting system will now be described in detail.

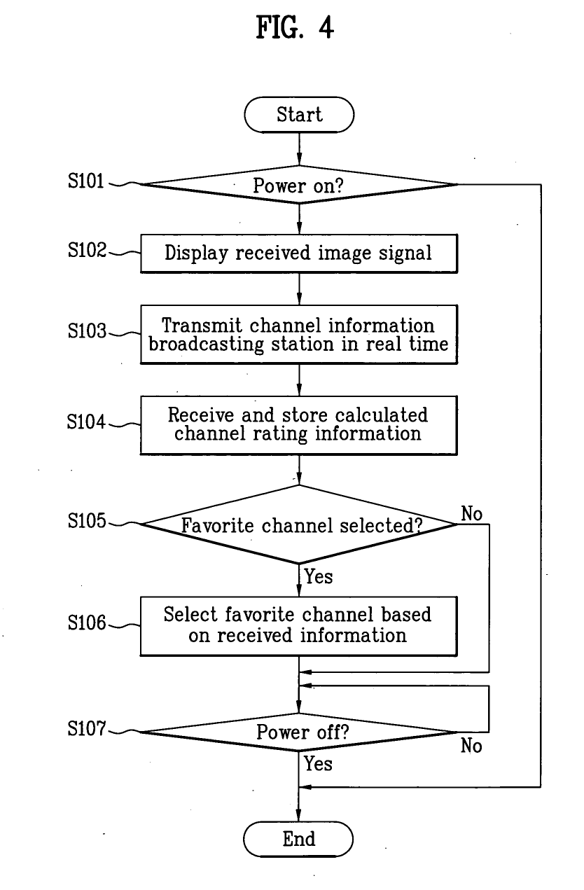

FIG. 4 a flowchart illustrating a method for controlling a broadcasting system according to an embodiment of the present invention. This method can be implemented in the system of FIG. 3 or other suitable device/system.

Referring to FIG. 4, when a viewer (or a user) inputs a turn-on command to the display device 200 by using the remote controller 214 or the keypad 216 (S101), the display device 200 is turned on and the tuner selects a channel. The controller 217 displays an image signal of the selected channel on the display unit 221 (S102).

Whenever the viewer changes or selects a channel, the controller 217 transmits information about the changed or selected channel to the server 120 in real time (S103), or periodically transmits information about a channel and a broadcasting program currently viewed by the viewer to the server 120. The selected-channel information includes a number and a selection time of the selected channel, or includes a number, a viewing start time and a viewing time period of the currently-viewed channel. Also, the controller 217 may transmit the channel selection history and the channel viewing history stored in the storage 219 to the server 120.

The server 120 receives the selected-channel information, the channel selection history, and the channel viewing history from each of the plurality of the display devices 200 and stores them. Thereafter, the server 120 calculates a channel rating in real time based on the selected-channel information, and generates channel rating information based on the calculated channel rating. The channel rating information includes a channel number and the popularity of channels among a group of viewers at the different display devices 200. Also, the server 120 calculates a daily channel rating, a weekly channel rating, and a monthly channel rating based on the channel selection history and/or the channel viewing history among a group of viewers at the different display devices 200, and may generate channel rating information based on the daily channel rating, the weekly channel rating, and the monthly channel rating. Thereafter, the server 120 transmits the channel rating information to the display device(s) 200 through a bi-directional network, or transmits the channel rating information to the display device(s) 200 through the transmitter 110.

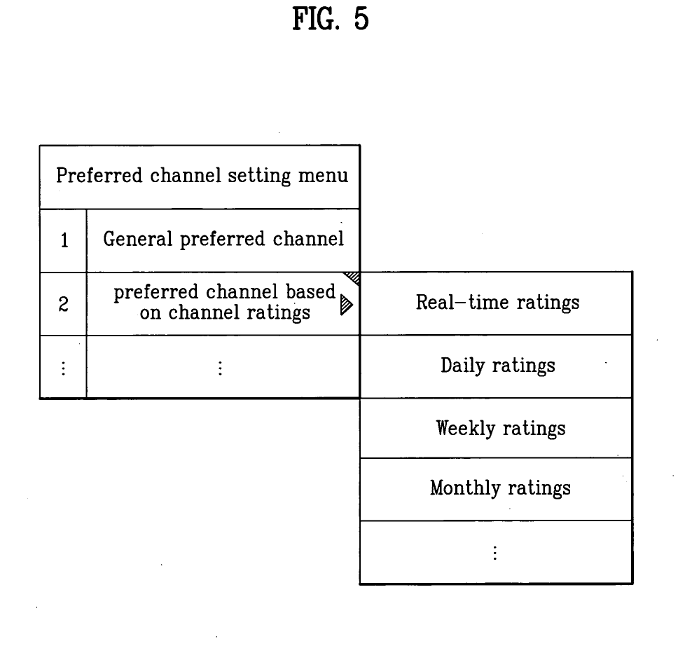

At each display device 200, the controller 217 receives the channel rating information from the server 120, and stores the received channel rating information in the storage 219 (S104). Also, the controller 217 determines channel priority based on the channel rating information. The channel priority can be determined based on any one of a real-time channel rating, a daily channel rating, a weekly channel rating, and a monthly channel rating. For example, as shown in FIG. 5, when the viewer selects one of the real-time channel rating, the daily channel rating, the weekly channel rating, and the monthly channel rating from the preferred channel setting menu, the controller 217 determines channel priority based on the selected channel rating. The storage 219 stores the determined channel priority.

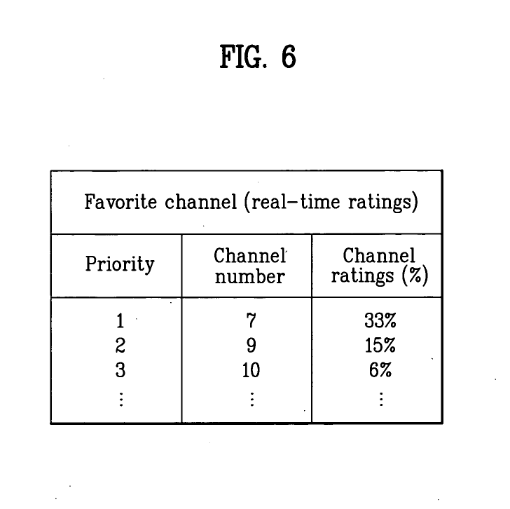

When the viewer inputs a favorite channel command through the remote controller 214 or the keypad 216 after the determination of the channel priority (S105), the controller 217 displays a favorite channel menu including the channel rating information on the display unit 221. FIG. 6 illustrates an example of the favorite channel menu. Referring to FIG. 6, the favorite channel menu includes a channel list according to the determined channel priority, and a channel rating. The viewer can select a favorite channel through the favorite channel menu.

Also, the controller 217 may automatically select a channel based on the stored channel priority and then display the selected channel. For example, whenever the viewer inputs a favorite channel command, the controller 217 can select/display one channel according to the stored channel priority. When the viewer inputs a turn-off command, the controller 217 stores the selected channel and cuts off the power.

As described above, the inventive broadcasting system can provide the viewer with information about popular channels. The viewer can select a channel through the provided channel information. Accordingly, the viewer can easily select a desired channel and notice those channels that are popular among other viewers.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for controlling a broadcasting system, the method comprising the steps of:
receiving channel rating information from a broadcasting station;
determining channel priority based on the received channel rating information; and
displaying channel information on a display device according to the determined channel priority.

2. The method of claim 1, wherein the channel rating information identifies channels most viewed by a group of viewers at different display devices.

3. The method of claim 1, further comprising the steps of:
transmitting selected-channel information from the display device to the broadcasting station; and
generating the channel rating information based on the transmitted selected-channel information.

4. The method of claim 3, wherein the selected-channel information is transmitted to the broadcasting station in real time when a channel is selected, or is periodically transmitted to the broadcasting station.

5. The method of claim 3, wherein the selected-channel information includes at least one of a selected channel number and a selection time of the selected channel.

6. The method of claim 3, wherein the selected-channel information includes at least one of a channel selection history and a channel viewing history stored in the display device.

7. The method of claim 1, wherein the channel rating information includes at least one of a real-time channel viewing rating, a daily channel viewing rating, a weekly channel viewing rating, and a monthly channel viewing rating.

8. The method of claim 1, wherein the displayed channel information includes at least one of a channel number listed according to the channel priority and a channel viewing rating.

9. A broadcasting system comprising:
a server of a broadcasting station, the server generating and outputting channel rating information; and
a display device to determine channel priority based on the channel rating information and to display channel information according to the determined channel priority.

10. The system of claim 9, wherein the channel rating information identifies channels most viewed by a group of viewers at different display devices.

11. The system of claim 9, wherein the display device transmits selected-channel information to the server via the Internet.

12. The system of claim 11, wherein the display device transmits the selected-channel information to the server in real time when a channel is selected, or periodically transmits the selected-channel information to the server.

13. The system of claim 11, wherein the selected-channel information includes at least one of a selected channel number and a selection time of the selected channel.

14. The system of claim 11, wherein the selected-channel information includes at least one of a channel selection history and a channel viewing history stored in the display device.

15. The system of claim 9, wherein the channel rating information includes at least one of a real-time channel viewing rating, a daily channel viewing rating, a weekly channel viewing rating, and a monthly channel viewing rating.

16. The system of claim 9, wherein the displayed channel information includes at least one of a channel number listed according to the channel priority and a channel viewing rating.

17. The system of claim 9, wherein the server generates the channel rating information based on selected-channel information received from a plurality of display devices.

18. The system of claim 9, further comprising a transmitter to transmit the channel rating information generated by the server, together with a broadcasting signal, to the display device.

19. A display device comprising:
a receiver to receive channel viewing rating information from an external source;
a controller to determine channel priority based on the received channel viewing rating information; and
a display unit to display channel information according to the determined channel priority.

20. The display device of claim 19, wherein the channel viewing rating information identifies channels most viewed by viewers at different display devices.

21. The display device of claim 19, further comprising:
a user input unit to select one of the most viewed channels identified in the displayed channel viewing rating information.
